(19) United States
(12) Patent Application Publication
(10) Pub. No.: US 2025/0247328 A1
(43) Pub. Date: Jul. 31, 2025

(54) METHOD AND APPARATUS FOR ACCESSING A NETWORK NODE WITHOUT ROUTE DISCOVERY

(71) Applicant: SIGNIFY HOLDING B.V., EINDHOVEN (NL)

(72) Inventor: GERHARDUS ENGBERTUS MEKENKAMP, VALKENSWAARD (NL)

(21) Appl. No.: 18/855,055

(22) PCT Filed: Apr. 5, 2023
(86) PCT No.: PCT/EP2023/058926

§ 371 Date: Oct. 8, 2024

(30) Foreign Application Priority Data
Apr. 11, 2022 (EP) 22167520.0

(51) Int. Cl. H04L 45/00; H04W 8/00; H04W 40/24

(52) U.S. Cl. CPC H04L 45/34; H04W 8/005; H04W 40/246

(57) ABSTRACT

The present invention provides network access to network nodes (e.g., Zigbee nodes) without route discovery by combined reading of neighbor tables and source routing. By repeatedly reading neighbor tables of all nodes in the network, powered nodes can be found. Neighbor tables of neighbors listed in the neighbor table of the first node are read by providing a source route which may be obtained by tracking from which node the neighbor table was read. Route selection may be controlled based on a route quality (e.g., path cost). The result of this process is a list of source routes to all nodes. It is then possible to communicate with all nodes in the network using source routing (e.g., to read the light state).

### FIELD OF THE INVENTION

The invention relates to the field of wireless communication networks, such as—but not limited to—radio frequency, RF, wireless mesh networks where routes are established using many-to-one route requests.

### BACKGROUND OF THE INVENTION

There is an ongoing trend to move more and more towards connected lighting systems, which enable all kinds of new features like (remote) scheduling, energy monitoring, sensor-based lighting control and asset management. In many cases these systems are installed in existing buildings, in which cases a wireless network is preferred to avoid having to deploy new cables (for lighting control) through the ceiling. Examples of such wireless network protocols which are used widely in current practice are open standards protocols like Zigbee, Thread, Bluetooth Low Energy (BLE), BLE mesh, Wi-Fi, Wi-Fi direct, and various proprietary network implementations built on top of the IEEE 802.15.4, IEEE 802.15.1 or IEEE 802.11 standards.

Lighting networks (e.g., Zigbee networks) are becoming larger so that up to 100 nodes may be installed. To reach a network node, Ad-hoc On-demand Distance Vector (AODV) route discovery may be used, which is based on a broadcast mechanism. In AODV, nodes discover routes in request-response cycles. A node requests a route to a destination by broadcasting a route request (RREQ) message to all its neighbors. When a node receives an RREQ message but does not have a route to the requested destination, it in turn broadcasts the RREQ message. Also, it remembers a reverse-route to the requesting node which can be used to forward subsequent responses to this RREQ. This process repeats until the RREQ reaches a node that has a valid route to the destination. This node (which can be the destination itself) responds with a route reply (RREP) message. This RREP message is unicast along the reverse-routes of the intermediate nodes until it reaches the original requesting node. Thus, at the end of this request-response cycle a bidirectional route is established between the requesting node and the destination.

Therefore, the larger the network the more costly route discovery becomes. Consider a Zigbee network with 20 nodes. A bridge or gateway may see 15 neighbors and would require 5 route discoveries for which roughly 200 messages need to be sent. In a Zigbee network with 100 nodes, the bridge/gateway may see 26 neighbors since this is the common maximum number of neighbors which still fits in a single link status message. While it would be possible to register more neighbors and send multiple link status messages this is rarely used. Therefore, for a 100-node network, 74 routes would need to be discovered if an application would like to communicate with all nodes in the network. Since a single route discovery can easily require 200 messages in a 100-node network, about 15.000 messages would be needed for 74 discoveries.

Canadian patent application CA 2922449 A1 discloses a method to optimize routing in localized dense networks. A packet is received at a first network device in a network. An optimal route for the packet to a neighbor network device in the network is determined using a Source Routing Table (SRT), wherein the SRT includes an optimized routing table and a standard routing table, and wherein the optimized routing table comprises a list of neighbor network devices that the first network device can route to directly and wherein the standard routing table comprises a ZigBee source routing table. The packet is preferably routed using the optimal route.

### SUMMARY OF THE INVENTION

It is an object of the present invention to provide a node access scheme with reduced signaling effort for a user device joining a mesh network.

This object is achieved by a user device as claimed in claim 1, by a system as claimed in claim 12, by a method as claimed in claim 14, and by a computer program product as claimed in claim 16.

According to a first aspect, a user device is provided for accessing a wireless communication network comprising an apparatus for controlling the user device to provide access to a network node of a wireless communication network via a proxy device, wherein communication between the user device and the proxy device uses a single-hop communication protocol and communication within the wireless communication network uses a multi-hop communication protocol, and wherein the apparatus is configured to:
retrieve from the proxy device neighbor information about at least one neighbor node of the proxy device; and
build a source route to the network node by using source routing to connect to retrieved neighbor nodes and
recursively retrieve neighbor tables of discovered networks nodes in the wireless communication network, at the same time keeping track of source routes until all desired network nodes of the wireless communication network, including the network node, are found and source routes to those network nodes in the wireless communication network are obtained.

According to a second aspect, a method is provided for controlling a user device to provide access to a network node of a wireless communication network via a proxy device, wherein communication between the user device and the proxy device uses a single-hop communication protocol and communication within the wireless communication network uses a multi-hop communication protocol,
wherein the method comprises:
retrieving from the proxy device information about at least one neighbor node of the proxy device; and
building a source route to the network node by using source routing to connect to retrieved neighbor nodes and
recursively retrieving neighbor tables of discovered networks nodes in the wireless communication network, at the same time keeping track of source routes until all desired network nodes of the wireless communication network, including the network node, are found and source routes to those network nodes in the wireless communication network are obtained.

According to a third aspect, a system is provided, that comprises at least one user device of the first aspect and at least one proxy device for providing access to a network node of the wireless communication network, wherein the proxy device is a combo node configured to communicate with the user device by using a single-hop communication protocol, in particular a BLE protocol, and to communicate with the network node of the wireless network by using a multi-hop communication protocol, in particular a Zigbee protocol.

According to a fourth aspect, a computer program product is provided, which comprises code means for producing the steps of the above method of the second aspect when run on a controller device.

Accordingly, an external node (i.e., user device) may connect to a (mesh) network without requiring a route discovery process. Instead, upon connecting to the network, the external node recursively proceeds to read neighbor tables of available nodes in the mesh network, at the same time keeping track of the source routes. To prevent that nodes need to discover a route to the external node, the external node may initiate a many-to-one route request before reading the neighbor tables.

Although in accordance with the above aspects, it may be possible to establish source routes to all desired nodes, the procedure may be configured to stop when source routes to all desired nodes have been found. It is not a given that when a user device connects to the mesh network it needs to read information from all nodes in the network to control the network nodes within a room.

However, optionally, the apparatus in the user device may be configured to recursively read neighbor tables of networks nodes in the wireless network, at the same time keeping track of source routes until no more new network nodes are found and a list of source routes to all available network nodes in the wireless network is obtained. Thus, an efficient node discovery and access scheme can be provided based on available source routing and neighbor table provision mechanisms.

Thus, retrieving the state of nodes and/or controlling of the nodes can be achieved by combining reading of neighbor tables with source routing. More specifically, the approach is to read the neighbor table of a first node to obtain a list of neighbors. Next, the neighbor tables of these neighbors are read. When this process is repeated until no more new nodes are found, the process terminates. As a result, a list of all nodes in the network that were powered on is obtained. By combining reading of neighbor tables with source routing, a list of routes to all nodes in the network is obtained. The source routing can be achieved by keeping track of the sequence of steps needed to reach a neighbor of a neighbor. The use of source routing provides the external node with fine-grained control over the discovery process and reduces the overhead of device discovery, as it does away with the need for flooding and/or broadcasts. Thereby, all powered nodes and routes can be found. Nodes which are powered down don't take additional time. Trying AODV route discovery to a powered down node will eventually lead to a timeout (e.g., about 1.6 s in Zigbee networks). AODV route discovery is based on broadcasting. In Zigbee networks, a broadcast transaction table is provided to keep track of ongoing broadcasts and thereby limit the amount of broadcasts to about 3 per second.

Consider a lighting network that shall be accessed via BLE using a Zigbee Direct (proxy) node. A user device (e.g., mobile phone) connects to the BLE/Zigbee proxy node and wants to read the status of all lights. When the user starts the app, the number of routes is unknown. The proxy node may have a list of routes available from a previous use, but if the proxy node was power-cycled there may not be any routes available. Consider a 30-node network. If the proxy node sees 15 neighbor nodes and has no other routes, 15 route discoveries are needed, requiring about 900 messages. Combining the reading of neighbor tables with source routing, the neighbor tables of 30 nodes would need to be read. Since neighbor table entries are quite large (e.g., 22 bytes), it may take 10 to 12 reading operations and responses to get a neighbor table. Thus, reading the neighbor tables of all nodes would require roughly 2*12*30=720 messages. To improve the efficiency of reading neighbor tables a new vendor specific attribute or Zigbee Cluster Library (ZCL) command can be used. Such an attribute or command would only provide the neighbor table data which is relevant for the algorithm. For example not reporting the extended panId and the extended address would reduce the 22-byte payload by 16 bytes. Providing the 16-bit network address, a representation of the link cost and some flags is sufficient, this allows providing up to 25 neighbors in a single read. This is especially important to obtain optimized access time in standalone networks. Subsequently regular OADV route discovery may be applied at a slow-paced interval (e.g., 1 route per 3 seconds) to replace source routing.

According to a first option of any one of the first to fourth aspects, the apparatus may comprise a Zigbee Virtual Direct (ZVD) device functionality for connecting to a Zigbee Direct device (ZDD) comprised in the proxy device. Thereby, a tunneling protocol can be used for direct access between the user device and the proxy device without a need for additional gateway hardware.

In an example, the neighbor tables may be read by using a Zigbee Mgmt_Lqi_req command or a vendor-specific command or attribute.

According to a second option of any one of the first to fourth aspects, which may be combined with the first option, directed source-routed state information requests may be issued to collect state information from discovered network nodes of the wireless network. Thereby, the status of a retrieved neighbor node can be obtained with little signaling effort, so that signaling load on the wireless network can be minimized.

According to a third option of any one of the first to fourth aspects, which May be combined with the first or second options, node discovery and state information collection may be balanced by exploiting parallelism between neighbor detection and state information collection once controllable nodes are discovered while topology detection is still in progress. Thereby, time delays involved in the process of building source routes to access specific target nodes can be reduced.

According to a fourth option of any one of the first to fourth aspects, which may be combined with any one of the first to third options, node discovery and state information collection may be controlled by prioritizing at least one of obtaining the state information of discovered controllable devices, obtaining the state information of controllable devices in a target room, obtaining the state information of controllable devices displayed on a user interface of the user device, and obtaining the state information of controllable devices in a current room. Thereby, time delays involved in the process of building source routes to access specific target nodes can be reduced by focussing the node discovery and state information collection process on predetermined areas and/or types of network nodes.

According to a fifth option of any one of the first to fourth aspects, which may be combined with any one of the first to fourth options, a many-to-one route request may be initiated before obtaining the neighbor information. This measure provides the advantage that network nodes are informed about available routes back to the user device or proxy device to minimize signaling load required for forwarding the response to the user device.

According to a sixth option of any one of the first to fourth aspects, which may be combined with any one of the first to fifth options, the source route may be built by keeping track of a sequence of steps needed to reach a neighbor node of a neighbor node. Thus, efficient source routing can be achieved by tracking the process of neighbor node discovery.

According to a seventh option of any one of the first to fourth aspects, which may be combined with any one of the first to sixth options, a calculated cost of a registered source route of a retrieved neighbor node may be compared with a calculated cost of an obtained new source route of the retrieved neighbor node in order to decide whether to replace the registered source route by the new source route. Thereby, cheapest source routes are registered for retrieved neighbor nodes to optimize the source routing process.

According to an eighth option of any one of the first to fourth aspects, which may be combined with any one of the first to seventh options, link quality information may be obtained from the neighbor information and used for cost calculation of the source route. Thus, cost calculation for source routes can be optimized by considering the available link quality on the source route.

According to a ninth option of any one of the first to fourth aspects, which may be combined with any one of the first to eighth options, the retrieved neighbor nodes may be configured to reverse the source route and use the reversed source route as routing information to route a response towards the user device. Thus, the retrieved neighbor nodes can derive available routes back to the user device or proxy device to minimize signaling load required for forwarding the response to the user device.

It is noted that the above apparatus may be implemented based on discrete hardware circuitries with discrete hardware components, integrated chips, or arrangements of chip modules, or based on signal processing devices or chips controlled by software routines or programs stored in memories, written on a computer readable media, or downloaded from a network, such as the Internet.

It shall be understood that the user device of claim 1, the system of claim 12, the method of claim 14 and the computer program product of claim 16 may have similar and/or identical preferred embodiments, in particular, as defined in the dependent claims.

It shall be understood that a preferred embodiment of the invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

### In the Following Drawings:

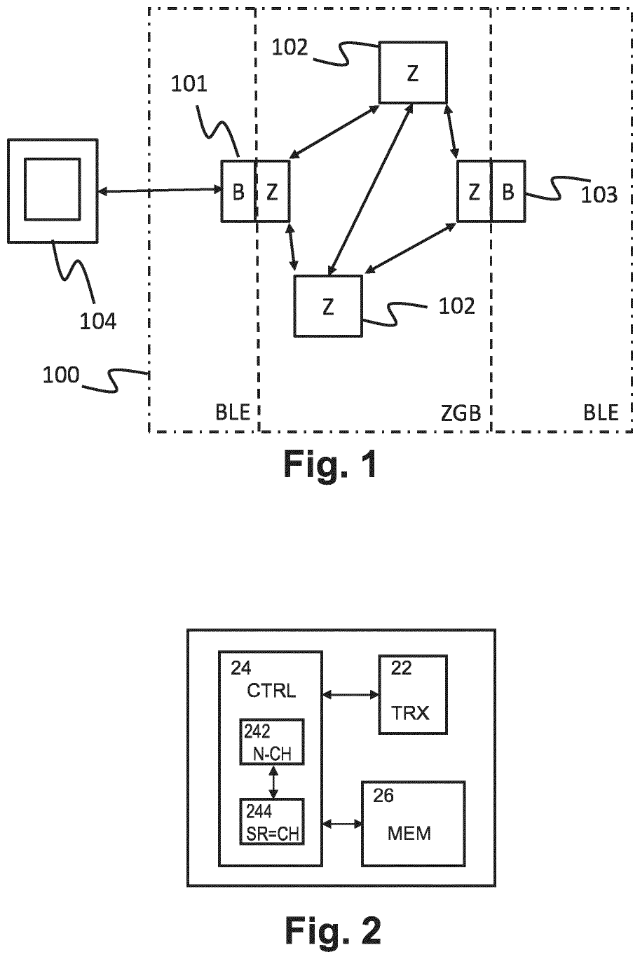

FIG. 1 shows schematically a block diagram of a network architecture in which various embodiments can be implemented;

FIG. 2 shows schematically a block diagram of a user device with node access function according to various embodiments;

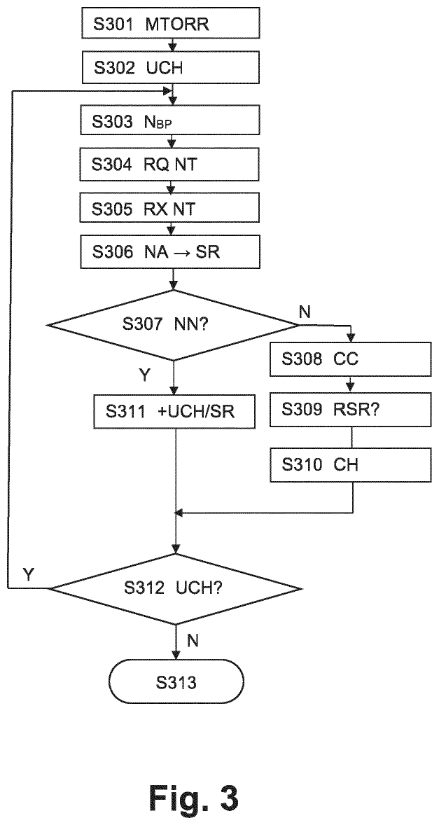

FIG. 3 shows a flow diagram of a node determination and route selection procedure according to various embodiments;

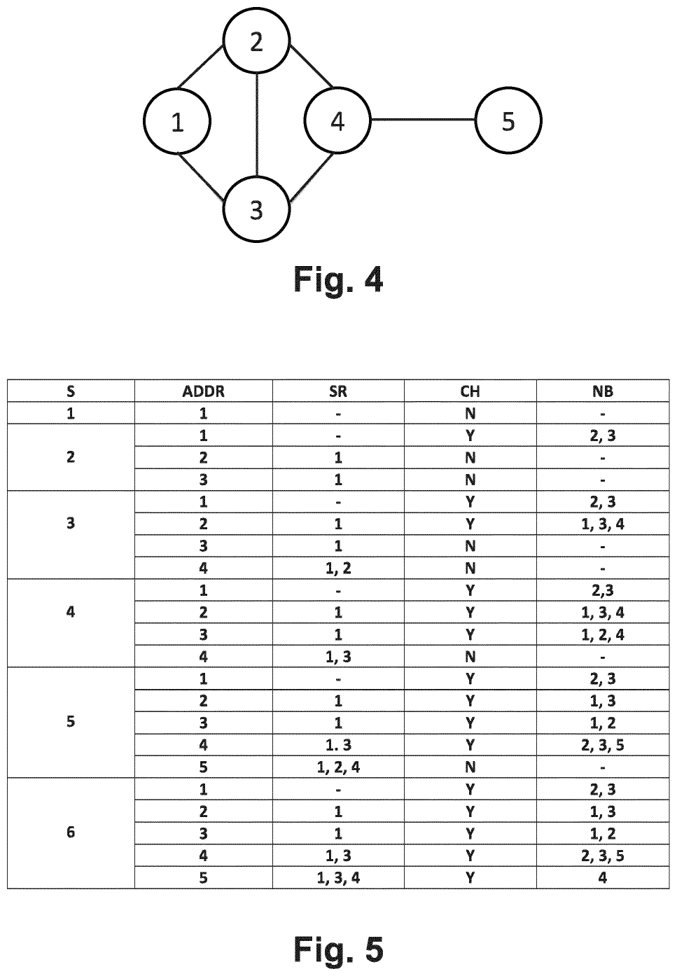

FIG. 4 shows schematically an exemplary network structure with five network nodes; and

FIG. 5 shows an exemplary table for explaining the node determination and route selection procedure based on the examplary network structure of FIG. 4.

### DETAILED DESCRIPTION OF EMBODIMENTS

Various embodiments of the present invention are now described based on a wireless communication system such as—but not limited to—a Zigbee lighting network. In Zigbee networks, a many-to-one routing request (MTORR) can be used in combination with source routing. The MTORR will enable nodes in the network to establish a path to the originator of the node, with limited overhead. This can be useful in wireless sensor networks where a gateway/bridge sends an MTORR enabling sensors to thereafter reach a gateway/bridge. When a sensor has data that it wants to send to the gateway/bridge, it also sends a route record which contains the route to the sensor. The gateway/bridge can store received route records and build a source routing table. When the gateway/bridge wants to read additional data from the sensor, it can include the source route in the message. A source route is essentially a list of hops which is attached to a message.

However, in a lighting network, which comprises lighting nodes, but no gateway or bridge, and where a mobile device connects to the network by means of a lighting node in proximity and wants to retrieve the state of the lights in the lighting network, this solution does not easily apply. In such a scenario the light would need to initiate the communication to retrieve the status of light nodes in the network. In an example, broadcasting a read status message to all lighting nodes, getting a response from all lighting nodes, and collecting the source routes may be possible. However, since all lighting nodes respond simultaneously, this may result in a broadcast storm, and/or failure to receive the status of all responding lighting nodes.

In systems with a gateway or bridge, the routes can be collected over a long period of time. However, there are several situations in which routes to many nodes are needed:

In a stand-alone setup (e.g., Zigbee Direct), a mobile phone may connect to a Zigbee network through a proxy node. This proxy node may not have many routes setup to other nodes in the network, while a running application (“app”) of the mobile phone may be configured to display a light status quickly and allow the user to control any light. A further advantage of the invention is that the mobile phone, which nowadays are powerful computing platforms, having ample memory and processing power, can collect the information and perform all relevant processing, whereas at the same time, the resource requirements for the network nodes (lights, switches) remains low.

In a stand-alone network (e.g., without gateway), it may be desirable to access all nodes with a mobile device. For example, to deploy a new timer schedule or read energy statistics.

In system with a gateway, routes may need to be re-established after a power failure. This means in a large network it will take quite some time before the network is operational again after reboot.

According to various embodiments, a node access mechanism is provided, which enables communicating with all nodes in the network without using route discovery commands.

FIG. 1 shows an architecture of a Zigbee mesh network 100 with Zigbee/BLE (Z/B) combo nodes 101, 103, in which various embodiments can be implemented.

It is noted that-throughout the present disclosure—the structure and/or function of blocks with identical reference numbers that have been described before are not described again, unless an additional specific functionality is involved. Moreover, only those structural elements and functions are shown, which are useful to understand the embodiments. Other structural elements and functions are omitted for brevity reasons.

When considering wireless networks, “standalone connected” wireless networks have been proposed that can be operated without a gateway. The setup and configuration of such a standalone connected wireless network e.g. as a Zigbee network and the devices therein may happen through an application on a mobile device (user device) 104, such as a smartphone, using a BLE connection from the mobile device 104 to a Zigbee/BLE combo node 101 (e.g., a retrofit luminaire). The Zigbee/BLE combo node 101 with which the mobile device 104 connects via BLE can be used as a proxy into the Zigbee network. By connecting to the single Zigbee/BLE combo node 101 over BLE, the mobile device 104 can connect to and control any of the other nodes 102, 103 in the Zigbee mesh network 100.

In an example, the combo nodes 101 and 103 may be Zigbee Direct devices (ZDDs) which are configured to allow an external device (e.g., the mobile device 104) to connect to the Zigbee network 100. Zigbee Direct is a standard that creates a tunneling protocol between Zigbee and Bluetooth Low Energy (BLE) devices without the need for additional gateway hardware. It makes use of BLE's generic attribute profile (GATT). A Zigbee Virtual Device (ZVD) is provided (e.g., as an app) on the external device (e.g., the mobile device 104) and acts as a central device and the ZDD (e.g., combo nodes 101, 103) as a peripheral device. The ZDD sends connectable advertisement if it is ready to connect to one or more ZVDs. On connection (and authentication), a ZVD gets added to ZDD's neighbor or child table and is treated by the local stack as yet another Zigbee device (e.g., with a different MAC identifier).

In an exemplary Zigbee Direct setup, a ZVD (e.g., mobile phone) may scan for BLE devices. To recognize whether a BLE device is a ZDD or any other type of device, the underlying Zigbee Direct specification may define which data shall be provided in an advertisement (e.g., beacon). To create a ZDD, the advertisement may include a 16-bit Zigbee Direct service identifier (e.g., “0xFFF7”). This service identifier may be standardized with the Bluetooth Special Interest Group (SIG) and may be registered as used by Zigbee Connectivity Standards Alliance (CSA). Furthermore, a personal network area (PAN) identifier (panID) may be provided in the ZDD advertisement. Based on the panID, the ZVD may filter if BLE devices belong to the network it wants to connect to. For convenience, the advertisement data may also contain a short address of the ZDD. When the ZVD has detected ZDDs, it may set up a connection to one ZDD. The selection may be based on a received signal quality (e.g., received signal strength indication (RSSI)) or other parameter(s) such as e.g. last usage.

In this manner, the mobile device 104 can be used to directly communicate with one of the combo nodes 101, 103 that support both Zigbee and BLE protocols. In embodiments, the combo nodes 101, 103 may use a combo chip arranged to operate in accordance with one out of the two different communication protocols (e.g., a single-hop communication protocol (such as BLE) and a multi-hop communication protocol (such as Zigbee) at a time. Thereby, a part of the processing resources could be re-used to provide a more cost-efficient solution. Alternatively, the combo chip may comprise one or more chips or transceivers that enable the device to operate in both networks in parallel. In an example, two separate chips may be placed back-to-back so as to bridge two distinct wireless networks.

In computer networking, source routing (sometimes also called “path addressing”) allows a sender of a packet to partially or completely specify a route the packet takes through the network. By contrast, in conventional routing, routers in the network determine the path incrementally based on the packet's destination. Source routing allows easier troubleshooting, improved traceroute, and enables a node to discover all possible routes to a host.

Dynamic Source Routing (DSR) is a routing protocol for wireless mesh networks. It is similar to AODV in that it forms a route on-demand when a transmitting node requests one. However, it uses source routing instead of relying on the routing table at each intermediate device. More specifically, DSR is an on-demand protocol designed to restrict the bandwidth consumed by control packets in ad hoc wireless networks by eliminating the periodic table-update messages required in the table-driven approach. The major difference between this and the other on-demand routing protocols is that it is beacon-less and hence does not require periodic hello packet (beacon) transmissions, which are used by a node to inform its neighbors of its presence. The basic approach of this protocol (and all other on-demand routing protocols) during the route construction phase is to establish a route by flooding route request packets in the network. The destination node, on receiving a route request packet, responds by sending a route reply packet back to the source, which carries the route traversed by the route request packet received.

In a regular Zigbee network, each Zigbee router node may send a link status message approximately every 15 s. With this link status message, neighboring nodes will be able to update their neighbor tables with a correct link cost for their neighbors, as measured by those neighbors (outgoing link cost). The link status message may be a single-hop broadcast message.

Routing protocols use the “cost” of a link as a metric to try to describe a penalty for using a particular link. The shortest path may then be the path with the least penalty or least cost. In route resolutions, costs may be assigned based on e.g. hop count, bandwidth and/or latency of a link. Optionally, the costs may be changed to achieve traffic engineering results (i.e., steering the traffic).

In a standalone Zigbee network without fixed gateway, there is no fixed/single entry into the Zigbee network, from which the mobile device 104 could reach all other nodes. By contrast, the standalone Zigbee network of FIG. 1 with the multiple combo nodes 101, 103 (to which the mobile device 104 can randomly connect), the mobile device 104 may communicate with other nodes 102 of the Zigbee network 100 through one of the combo nodes 101, 103 as proxy by using e.g. the BLE protocol.

Communicating through the one selected proxy with multiple nodes on the Zigbee network has multiple advantages. It allows a user to avoid a tedious identification of individual nodes before establishing the 1:1 BLE connection, eliminates the repetitive connection time (which can be in the range of 1 to 2s per connection per node, depending on the discovery and security method used) and allows further time saving thanks to parallelizing operations on the network. Rather than reading the node status one by one, the mobile node 104 can request a status update from all nodes in broadcast, or from multiple nodes in unicast, and collect the responses as they are received. Thereby, overall network latency can be reduced significantly when sending messages via an arbitrary proxy node to one or more other Zigbee nodes in the network.

According to various embodiments, the mobile device 104 (e.g., a ZVD) may be configured to connect in an ad hoc fashion to the Zigbee network 100 (e.g., a home network) via one of the combo nodes 101, 103 (e.g., ZDDs) to enable quick access to controllable devices in a fast manner without adding substantial signaling load. To achieve this, the Zigbee network 100 may be configured to allow source routing, so that the mobile device 104 sending a package can specify a route the packet shall take through the Zigbee network 100.

Furthermore, the mobile device 104 may be configured to obtain information the about Zigbee network 100 (e.g., information about network nodes that it can control and/or their status (optionally about all network nodes and/or their status)). This can be achieved by configuring the mobile device 104 to collect neighbor tables of at least some of the network nodes 101, 102, 103 in the Zigbee network 100 and discover at least some remaining network nodes using the neighbor tables. In parallel to this node discovery, the device may also use source routing to retrieve further neighbor tables and state information from discovered nodes.

In an example, the mobile device 104 may be configured to read neighbor tables in the Zigbee network 100 through a Mgmt_Lqi_req command of the Zigbee device profile. This request is sent e.g. via source routing to a device indicated by a short address to ask it to return its neighbor table. Being able to respond to this command is mandatory in Zigbee.

Optionally, reading of the neighbor information can be optimized at the cost of not being able to use this optimization on devices external to the wireless network. In a wireless network with external devices (e.g., 3rd party luminaires), a standard Mgmt_Lqi request may be sent to network-related (“internal”) luminaires. Since these internal luminaires and their capabilities are known upfront, an optimized command can be sent to each light. As an example, reading of a light state of a luminaire in a Zigbee network may require up to three messages depending on the capabilities and on/off state. For colored light, on/off cluster, level control cluster and color cluster may need to be read. Internal luminaires may be provided with a vendor-specific advanced light control cluster that is configured to support reading the light state in a single read to thereby optimize the reading process.

Thus, in embodiments, the mobile device 104 can perform neighbor table discovery focusing on devices that are controllable and may then issue directed “source routed” state information requests to start collecting state information of discovered nodes. In this manner, the amount of packets in the network (i.e., signaling load) can be kept small.

Although the mobile device 104 obtains information about the controllable devices, the controllable devices may need state and/or routing information of the mobile device 104. Otherwise, they need to discover routing paths, which increases signaling overhead.

In embodiments, it is therefore proposed to configure the mobile device 104 to connect to the Zigbee network 100 and trigger a MTORR e.g. at one of the combo nodes 101, 103. As a result, all nodes in the Zigbee network 100 are informed about a route to the mobile device 104. Alternatively, in response to the source-route based state information request, each addressed node may be configured to “reverse” the source route and use that routing information to route the response towards the mobile device 104. Either solution allows the state information (status) to be directly sent to the mobile device 104.

Wireless communication networks such as discussed herein find deployment, in home, office and/or other (building) automation system. Often many nodes in such systems are “application” nodes, such as for lighting applications, HVAC application, security applications and/or window treatment systems (e.g. blinds, shutters, louvres). In a smaller consumer setting, these may also encompass a wide-variety of consumer electronics Internet-of-Things devices. Quite often such devices are part of a wireless communication network to facilitate control, control that with the mass-proliferation of mobile phones and other portable electronic devices has become personal control.

Control operation may involve switching devices on or off, or switching modes of operation, such as for example the intensity of colour of light source in case of a lighting application. In order to facilitate control, electronic control devices often come with a user-friendly user interface, which may also require reproduction on the user interface of the current state of such controllable devices. For this reason the claimed invention may be used to build up a source route to a network node that a user wants to control, to allow the user device to collect the current status of the network node using a unicast command send using source routing and to enable the network node to relay such information to the user device, for reproduction on the mobile device and allow the user to issue a control command to the network device using a unicast command that uses the same source route.

In embodiments, node discovery and state collection may be balanced by exploiting parallelism between neighbor detection and state collection once controllable nodes are discovered while topology detection is still in progress. Initially, node discovery may be prioritized. Then, the discovery process can continue, but requests for state information may also be sent in parallel to discovered nodes using source route addressing. In an example, once the discovery process is moving along different routes, status collection may be started for previously discovered nodes at limited cost. Thereby, a trade-off between overall topology discovery and reduced latency of state collection can be achieved.

In embodiments, knowledge of the home network can be exploited by favouring node discovery and status collection in known areas (e.g., complete rooms or other target spaces). As the mobile device 104 may have information about the home network (e.g., which particular luminaires are in a particular room or other target space), this information may be used to prioritize discovery of controllable nodes in a room. Thereby, collection of state information for a limited target space can be accelerated and readily presented on a user interface of the mobile device 104. In examples, an app on the mobile device 104 may be configured to use rooms as “units” for displaying controllable devices. Thus, status collection may be targeted on a room and node discovery may be steered accordingly to thereby allow faster display of the state of a room (masking latency), taking into account related information available on the mobile device 104 and what is to be displayed on the user interface of the mobile device 104.

In an example, an app of the mobile device 104 has information about nodes in the network 100 and displays nodes on a “room basis” on its user interface. Then, state collection can be focussed on the displayed controllable nodes of the current room. Assuming that a user might want to control controllable devices in the current room, which will then be displayed, state discovery for these controllable devices can be favored by steering discovery towards nodes known to be in the same room.

As a further option, existing information about nodes in rooms can be leveraged e.g. by prioritizing nodes that are known to be in the same room as a Zigbee device to which the mobile device 104 connects. Thus, the search can be steered to neighboring nodes that are known to be in the same room (and/or later to neighboring nodes that are known to be in adjacent rooms, or on the same floor).

In an embodiment, node discovery may be focussed on controllable devices currently presented on a user interface of the mobile device 104. As an app on the mobile device 104 may open up a page which displays certain controllable nodes (which may actually be located in another room), the focus of node discovery can be placed on these nodes although located in this other room. When information about adjacent rooms is available, such information can be used to steer the node discovery.

Thus, as described above, the underlying mechanisms of node discovery (neighbor table collection) and state collection (source routing) may be controlled with a focus on at least one of obtaining a state of discovered controllable devices, obtaining a state of controllable devices in a target room, obtaining a state of controllable devices displayed on a user interface of the mobile device 104, and obtaining a state of controllable devices in a current room.

FIG. 2 shows schematically a block diagram of a user device (e.g., the mobile device 104 of FIG. 1) with node access function according to various embodiments.

The user device may be a wireless network node which comprises a transceiver (TRX) 22 configured to communicate using at least a first wireless communication protocol (e.g., BLE) to communicate with one of the combo nodes 101, 103 of FIG. 1 using the first communication protocol.

Furthermore, the user device may comprise a controller (CTRL) 24 and a memory (MEM) 26 for storing routing table(s), node information and the like. It will be understood by those skilled in the art, that the memory 26 and the controller 24 may be separate physical entities within the user device or may represent logical entities, e.g., in case the functionality is implemented in a single physical entirety, such as an integrated circuit (e.g., an application specific integrated circuit (ASIC)).

Furthermore, the controller 24 of the user device may comprise a node checking functionality (N—CH) 242 and a source route checking functionality (SR—CH) 244, which are configured to provide (separately or interactively) node discovery and state collection processes of the proposed node access function according to the embodiments described herein. The node checking and source route checking functionalities 242, 244 may be software-implemented by software routines configured to control the controller or may be hardware-implemented by building respective blocks of a digital chip (e.g., ASIC or field programmable gate array (FPGA)) based on a hardware description language.

FIG. 3 shows a flow diagram of a node determination and route selection procedure for the proposed node access scheme according to various embodiments.

The procedure starts with a single node. For example, in case of the upcoming Zigbee Direct standard, a ZDD may be used as a proxy (e.g., combo node 101 or 103 of FIG. 1) to connect a mobile phone (e.g., mobile device 104 in FIG. 1) to a Zigbee network (e.g., network 100 of FIG. 1) e.g. via BLE. The address of the ZDD is used as a starting point (e.g., stored or set at the mobile phone (e.g., at the ZVD)) and the neighbor table of the ZDD is read via a respective command (e.g., a Mgmt_Lqi_req command).

In case a bridge or gateway is provided in the network, the procedure may start with a list of neighbors of the bridge/gateway.

According to the proposed node access scheme, source routes are built (e.g., by the source route checking functionality 244 of FIG. 2) while reading neighbor tables (e.g., by the node checking functionality 242 of FIG. 2) and registering found results (e.g., in a list or table of the memory 26 of FIG. 2). To prevent loops, a registered source route is only replaced, if its associated cost is lower than the cost of the previously registered one. The cost may be as simple as counting the number of hops (i.e., the length of the source route). The neighbor tables may also contain a link quality indicator which may be used for an improved cost calculation by combining the link quality indicator in the source route.

In a Zigbee neighbor table, the neighbors may not be the closest nodes (e.g., with a strongest signal). Rather, Zigbee stacks may be configured to deliberately introduce nodes that are further away in the neighbor tables to prevent having unreachable parts of a network. Therefore, including the link quality indicator when calculating cost for selecting source routes may be advantageous.

In step S301, an optional MTORR is triggered by the mobile phone to be broadcast from the first node (e.g., proxy ZDD) to allow other network nodes to answer. Then, in step S302, the first node is marked as unchecked (UCH).

In step S303, a (controllable) node (NBP) with the best path (e.g., “cheapest” path with lowest cost) is determined from all available unchecked nodes.

In step S304, the neighbor table of the determined node is requested (RQ NT) using the registered source route of the best path.

In step S305, the requested neighbor table is received (RX NT) from the addressed node.

Then, in step S306, the nodes of the retrieved neighbor table and their node addresses are retrieved and new source routes and their related cost are calculated by adding the respective node address (NA) (and related cost) to the registered source route (SR) of the determined node from which the neighbor table has been received.

In step S307, it is checked for each retrieved neighbor node of the received neighbor table whether the neighbor node is a new node (NN) which has not been registered yet.

If a checked node is not a new node (i.e., has been registered before), the procedure branches to step S308, where the cost of the registered source route for this node is compared (CC) with the related cost of the obtained new source route. Then, in step S309, the source route is replaced (RSR) with the new source route if the related cost of the new source route is smaller. If not, the “old” source route is maintained for the related node. In a subsequent step S310, the node is marked as checked (CH).

Otherwise, if a checked node is a new node, the procedure branches to step S311, where the new node is added/marked as unchecked node (UCH) and the new source route (SR) is registered.

After all nodes of the neighbor table have been checked in steps S307 to S311, the procedure continues with step S312 where it is checked whether any remaining unchecked nodes are registered. If not, the procedure ends with step S313. Otherwise, the procedure jumps back to step S303 where the next node (NBP) with the best path (e.g., cheapest path with lowest cost) is determined from all available unchecked nodes.

Optionally, the procedure may be configured to stop if all desired nodes have been found. It may not be necessary to read information from “leaf” nodes (e.g., nodes at the end of a network branch). For example, if the network has five nodes which are all in the ZDDs neighbor table, no further neighbor table reads are needed.

FIG. 4 shows schematically an exemplary network structure with five network nodes.

The examplary network structure may be a Zigbee network and comprises five nodes 1 to 5. Node 1 may be a combo node (e.g. ZDD) which acts as a proxy for an external device to contact the Zigbee network with the other nodes 2 to 5. Node 1 is connected to nodes 2 and 3, nodes 2 and 3 are connected to each other and to node 4, and node 4 is connected to node 5.

FIG. 5 shows an exemplary table for explaining a node determination and route selection procedure based on the examplary network structure of FIG. 4.

The table rows indicate successive registration states(S) during the route selection procedure which is based on the flow diagram of FIG. 3.

Furthermore, the table columns include addresses (ADD) of registered nodes, which correspond to the node numbers “1” to “5”, source routes (SR) to the registered nodes, which are indicated by a corresponding sequence of node numbers, checking status (CH) of the registered nodes, which is indicated by Yes (“Y”) or No (“N”), and neighbor nodes (NB) indicated by their node numbers.

Initially, in state 1, node 1 has been registered and marked as unchecked. Then, in state 2, the neighbor table of node 1 has been retrieved and neighbor nodes 2 and 3 have been read and registered. Node 1 has been marked as checked. Furthermore, a new source route “1” and a new node 2 have been registered and node 2 has been marked as unchecked. Additionally, a new source route “1” and a new node 3 have been registered and node 3 has been marked as unchecked.

In subsequent state 3, neighbor nodes 1, 3 and 4 of node 2 have been retrieved and node 2 has been marked as checked. Furthermore, a new node 4 has been added with source route “1, 2” and marked as unchecked.

In the following state 4, neighbor nodes 1, 2 and 4 of node 3 have been retrieved and node 3 has been marked as checked. Furthermore, a new (cheaper) source route “1, 3” has been registered for registered node 4.

In subsequent state 5, neighbor node 5 of node 4 has been retrieved and node 4 has been marked as checked. Furthermore, a new node 5 has been added with source route “1, 2, 4” and marked as unchecked.

Finally, in state 6, the neighbor node 4 of node 5 has been retrieved and node 5 has been marked as checked. Furthermore, a new node 5 has been added with source route “1, 2, 4” and marked as checked.

As no unchecked nodes are remaining is state 6, the node determination and route selection procedure ends here.

According to another embodiment, it may be determined in an initial step if the procedure of FIG. 3 or a regular route discovery procedure (e.g., AODV) should be used. If the number of nodes in the network is low and the number of neighbors is high, regular AODV routing may be favored. For example, in a 15-node network with 14 neighbors.

Instead of finding all nodes, it may also be possible to search for a specific set of nodes and terminate the procedure once routes to these nodes (with a sufficiently low link cost) have been found. This way the procedure may immediately terminate when all nodes are neighbors.

Since neighbor table entries are quite large (e.g., 22 bytes per neighbor), a vendor specific neighbor table read may be implemented. If link cost and network address is returned for each neighbor, only need 3 bytes are needed, so that the entire neighbor table may fit in one message (e.g., 16*3-48 bytes, while the effective Zigbee payload is about 75 bytes).

After obtaining source routes, light states or other state information may be read. Instead of waiting for the procedure to complete before reading light states, light states may be read during the procedure when routes with a sufficient quality are found. This may be used to speed up presenting light states of nearby lights in the user interface.

To summarize, network access to network nodes (e.g., Zigbee nodes) without route discovery through combined reading of neighbor tables and source routing has been described. By repeatedly reading neighbor tables of all nodes in the network, powered nodes can be found. Neighbor tables of neighbors listed in the neighbor table of the first node are read by providing a source route which may be obtained by tracking from which node the neighbor table was read. Route selection may be controlled based on route quality (e.g., path cost). The result of this process is a list of source routes to all nodes. It is then possible to communicate with all nodes in the network using source routing (e.g., to read the light state).

It will be understood that the controller referred to herein may in practice be provided by an integrated circuit or plural integrated circuits, an application-specific integrated circuit (ASIC), field-programmable gate array (FPGA), digital signal processor (DSP), etc.

Although at least some aspects of the embodiments described herein with reference to the drawings (e.g. FIGS. 3 and 5) comprise computer processes performed in a controller, the invention also extends to computer programs, particularly computer programs on or in a carrier or an app for a mobile device, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

While the invention has been illustrated and described in detail in the drawings and foregoing description, such illustration and description are to be considered illustrative or exemplary and not restrictive.

The invention may also be used in bridge-based systems. For example, in cases where a bridge was power cycled (hardware turned off and then on again) and has no more routes in its memory. In a bridge-based system, the bridge is part of the network and a BLE combo node may not be needed. Since the bridge is part of the Zigbee network it has a neighbor table (which may be maintained by processing link status messages from neighboring nodes). As a first step in the above procedure of FIG. 3, the bridge may read its own neighbor table. The procedure may even be identical if the bridge would be configured to literally send the first neighbor table read message to itself. However, in practical implementations, the bridge may directly access an own memory where the neighbor table is stored. Otherwise, apart from not using BLE, the flow may remain the same.

In an example, a component (e.g., software routing) in the bridge may trigger sending neighbor table read requests, collecting received data and building source route tables. To achieve this, the bridge may actually use two controllers or processors (CPUs). One processor my be configured to implement Zigbee and be responsible for sending and receiving messages in the network. The other processor may be responsible for a main application (e.g., receiving http messages, polling light states, and instructing the other (Zigbee) processor to send messages. The two processors may be connected using a serial link.

Although particularly advantageous in a standalone Zigbee network, the same principle may also be applied in other mesh networks that have multiple concentrators. In networks with a large number of concentrator/proxy nodes it is relevant to keep track of available routes in the network. When this is done it will be possible for mobile devices to connect ad hoc to the network and to be able to communicate, not only with the proxy, but also other nodes in the mesh network without having to wait for route discovery to complete.

Furthermore, the proposed node access concept is not limited to Zigbee networks and may be used in conjunction with other networks such as Thread, BT Mesh, Wi-Fi Mesh, JupiterMesh or other mesh topologies using multi-hop communication protocols.

The proposed approach may also be used in wireless mesh networks where, apart from the above described Zigbee/BLE combo nodes, other nodes that only support the multi-hop communication protocol or another single-hop communication protocol (e.g., WiFi, near field communication (NFC), cellular communication, etc.) are provided. Such nodes may be “legacy” Zigbee-only nodes or may be Zigbee/BLE capable nodes that have been configured (either prior to installation, during commissioning or during operation) to operate as Zigbee only nodes. For example, in networks with many Zigbee/BLE nodes that are in close proximity, it may be conceivable to configure some of the Zigbee/BLE router nodes as Zigbee End Devices, ZED, so as to simplify the network topology and reduce the need for route discovery.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. The foregoing description details certain embodiments of the invention. It will be appreciated, however, that no matter how detailed the foregoing appears in the text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated.

A single unit or device may fulfill the functions of several items recited in the claims. The mere fact that certain measures are recited in mutually different dependent claims does not indicate that a combination of these measures cannot be used to advantage.

1. A user device for accessing a wireless communication mesh network comprising an apparatus for controlling the user device to provide access to a network node of a wireless communication mesh network via a proxy device in the wireless communication mesh network, the user device external to the wireless communication mesh network, wherein communication between the user device and the proxy device uses a single-hop communication protocol and communication within the wireless communication mesh network uses a multi-hop communication protocol, and
wherein the apparatus is configured to:
retrieve from the proxy device neighbor information about at least one neighbor node of the proxy device; and
build a source route to the network node by using source routing to connect to retrieved neighbor nodes from said neighbor information and
recursively retrieve, using source routing, neighbor tables of discovered networks nodes from the retrieved neighbor tables in the wireless communication mesh network, at the same time keeping track of source routes to thus discovered network nodes until all desired network nodes of the wireless communication mesh network, including the network node, are found and source routes to the desired network nodes in the wireless communication mesh network are obtained.

2. The user device of claim 1, wherein the wireless communication mesh network is a Zigbee mesh network and the apparatus comprises a Zigbee Virtual Direct device functionality for connecting to a Zigbee Direct device comprised in the proxy device.

3. The user device of claim 1, wherein the desired network nodes are all available network nodes and the apparatus is configured to recursively read neighbor tables of networks nodes in the wireless network, at the same time keeping track of source routes until no more new network nodes are found and a list of source routes to all available network nodes in the wireless network is obtained.

4. The user device of claim 1, wherein wireless communication mesh network is a Zigbee mesh network and the apparatus is configured to read the neighbor tables by using a Zigbee Mgmt_Lqi_req command or a vendor-specific command or attribute.

5. The user device of claim 1, wherein the apparatus is configured to issue directed source-routed state information requests to collect state information from discovered network nodes of the wireless communication mesh network.

6. The user device of claim 5, wherein the apparatus is configured to balance node discovery and state information collection by exploiting parallelism between neighbor detection and state information collection once controllable nodes are discovered while topology detection is still in progress.

7. The user device of claim 5, wherein the apparatus is configured to control node discovery and state information collection by prioritizing at least one of obtaining the state information of discovered controllable devices, obtaining the state information of controllable devices in a target room, obtaining the state information of controllable devices displayed on a user interface of the user device, and obtaining the state information of controllable devices in a current room.

8. The user device of claim 1, wherein the apparatus is configured to initiate a many-to-one route request before obtaining the neighbor information.

9. The user device of claim 1, wherein the apparatus is configured to build the source route by keeping track of a sequence of steps needed to reach a neighbor node of a neighbor node.

10. The user device of claim 1, wherein the apparatus is configured to compare a calculated cost of a registered source route of a retrieved neighbor node with a calculated cost of an obtained new source route of the retrieved neighbor node in order to decide whether to replace the registered source route by the new source route.

11. The user device of claim 10, wherein the apparatus is configured to obtain link quality information from the neighbor information and to use the link quality information for cost calculation of the source route.

12. A system comprising at least one user device of claim 1 and at least one proxy device for providing access to a network node of the wireless communication network, wherein the proxy device is a combo node configured to communicate with the user device and wherein the single-hop communication protocol is the Bluetooth Low Energy protocol, and to communicate with the network node of the wireless communication mesh network uses the Zigbee protocol.

13. The system of claim 12, wherein the retrieved neighbor nodes are configured to reverse the source route and use the reversed source route as routing information to route a response towards the user device.

14. A method of controlling a user device to provide access to a network node of a wireless communication mesh network via a proxy device, in the wireless communication mesh network, the user device external to the wireless communication mesh network, wherein communication between the user device and the proxy device uses a single-hop communication protocol and communication within the wireless communication mesh network uses a multi-hop communication protocol,
wherein the method comprises:
retrieving from the proxy device information about at least one neighbor node of the proxy device; and
building a source route to the network node by using source routing to connect to retrieved neighbor nodes from said information and
recursively retrieving, using source routing, neighbor tables of discovered networks nodes from the retrieved neighbor tables in the wireless communication mesh network, at the same time keeping track of source routes to thus discovered network nodes until all desired network nodes including network node are found and source routes to the desired network nodes in the wireless communication mesh network are obtained.

15. The method of claim 14, wherein the desired of network nodes are all available network nodes and the apparatus is configured to recursively read neighbor tables of networks nodes in the wireless network, at the same time keeping track of source routes until no more new network nodes are found and a list of source routes to all available network nodes in the wireless network is obtained.

16. A non-transitory computer readable medium comprising instructions, the instructions when executed by a controller device cause the controller device to perform the method of claim 14.
